(19) United States
(12) Patent Application Publication
(10) Pub. No.: US 2009/0303255 A1
(43) Pub. Date: Dec. 10, 2009

(54) SYSTEMS AND METHODS FOR PROVIDING INFORMATION IN A RICH MEDIA ENVIRONMENT

(75) Inventors: Toni Juhani Paila, Koisjarvi (FI); Topi-Oskari Pohjolainen, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/390,458

(22) Filed: Feb. 21, 2009

Related U.S. Application Data
(60) Provisional application No. 61/030,880, filed on Feb. 22, 2008.

(51) Int. Cl. G09G 5/00; G06F 15/16

(52) U.S. Cl. 345/660; 709/231

(57) ABSTRACT

Systems and methods for providing session-related information in a rich media environment. In various embodiments, a reference to individual media fragments in a session may be identified in an SDP message. In further embodiments, different arrangements may be used to enable faster session and scene setup time by carrying SDP descriptions and the latest full scene documents. Various embodiments also use statistical multiplexing so that RME scene updates can be efficiently provided along with associated media streams.

### RELATED APPLICATION

This application claims priority to U.S. Application No. 61/030,880 filed Feb. 22, 2008, which is hereby incorporated by reference in its entirety.

### FIELD OF THE INVENTION

The present invention relates generally to rich media content and services. More particularly, the present invention relates to the providing of descriptive information that relates to rich media information.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Over the past few years, mobile device capabilities have been increasing at a rapid pace, resulting in devices which provide, for example, increased processing power, larger screen displays, and improved digital services. As a result, consumer demand for rich multimedia content and applications, such as on-demand services that can be delivered anywhere and anytime, has also increased. As used herein, rich media content generally refers to content that is graphically rich and contains compound/multiple media including graphics, text, video and/or audio. In addition, rich media can dynamically change over time and can respond to user interaction, while being delivered through a single interface.

Various types of rich media environment (RME) technologies may be used to provide information concerning media scenes and layouts, as well as to manage updates to such scenes and layouts. As used herein, RME may include Scalable Vector Graphics (SVG), Flash technology, Moving Pictures Experts Group (MPEG)-Lightweight Application Scene Representation (LASeR) technology, and other technologies.

Session description protocol (SDP) information may describe one or more video streams, one or more audio streams, and one or more RME streams including streams such as Dynamic and Interactive Multimedia Scenes (DIMS) streams, all of which are associated with a single session. Each stream is commonly referred to as an individual “media component” and is described by media sections of an SDP description, with each stream having its own value of “m” in the SDP description. Individual media components of an SDP description can be arbitrarily related to each other. For example, a session may include one video stream and two corresponding audio streams, with each audio stream carrying a different language of speech. Additionally, the session may also include in one embodiment two or more primary RME streams, each including scenes that are to be used according to different criteria, and two or more secondary RME streams, each providing updates to one of the primary RME streams. In SVG/RME, the audio/video and scene/update streams are referenced from within XML by “xlink:href” attribute. XML Linking language (XLink) is defined in www.w3.org/TR/xlink/ by the W3C organization. During the transmission of a session of multiple streams, statistical multiplexing provides a mechanism by which the use of available bandwidth can be maximized.

At a single moment, a terminal may be tuned to a primary RME stream that provides main scenes, a secondary RME stream that provides scene updates, one or more audio and streams, one or more video streams and one or more streams of auxiliary data such as images. Depending upon the content, the user may be capable of interacting with a current interactive scene, for example by selecting a menu choice. In such a situation, the terminal may tune to a new set of primary/secondary RME steams and audio/video streams. This involves retrieving the SDP descriptions, tuning into/joining the session and receiving the data. Furthermore, according to 3^{rd} Generation Partnership Project (3GPP) Dynamic and Interactive Multimedia Scenes (DIMS), the terminal may, once tuned, receive the full scene at some point in time, at which point the terminal will start applying scene updates.

### SUMMARY OF THE INVENTION

Various embodiments provide different systems and methods for providing session-related information in a rich media environment. According to various embodiments, a references to individual media fragments in a session may be identified in an SDP message. With the ability to identify references to individual media fragments, a single SDP message may be used when the combination of media components to be consumed changes in a session.

Various embodiments also use different arrangements to enable faster session and scene setup time by carrying SDP descriptions and the latest full scene documents. This may be accomplished, for example, by reusing a 3GPP DIMS unit for carrying scene and SDP information of sessions other than a current session. In other embodiments, Multipurpose Internet Mail Extensions (MIME) multipart methods may be used to amend the result of the fetching of content such that it includes additional scene and SDP information of sessions other than a current session. In still other embodiments, for a commonly shared session, a File Delivery Over Unidirectional Transport (FLUTE)-based carousel and associate change/update signaling may be used.

Various embodiments also use statistical multiplexing and relative prioritizing so that RME scene updates can be provided along with associated media streams in an efficient manner.

These and other advantages and features of various embodiments, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a flow chart showing an example implementation in which a “fref” attribute may be used to identify different media components;

FIG. 2 is a general representation showing a process by which statistical multiplexing may be used to provide RME scene update information along with associated media streams;

FIG. 3 is a representation showing how a relative prioritizer may be used in combination with statistical multiplexing in order to individual RME scene updates with associated media streams in an efficient manner;

FIG. 4 shows in detail a process by which a relative prioritizer may be used with statistical multiplexing in order to transmit individual RME scene updates with associated media streams in an efficient manner;

FIG. 5 is an overview diagram of a system within which various embodiments of the present invention may be implemented;

FIG. 6 is a perspective view of an electronic device that can be used in conjunction with the implementation of various embodiments of the present invention; and

FIG. 7 is a schematic representation of the circuitry which may be included in the electronic device of FIG. 6.

### DETAILED DESCRIPTION OF VARIOUS EMBODIMENTS

Various embodiments provide different systems and methods for providing session-related information in a rich media environment. According to various embodiments, references to individual media fragments in a session may be identified in an SDP message. With the ability to identify references to individual media fragments, a single SDP message may be used when the combination of media components to be consumed changes in a session.

According to these embodiments, a single SDP description is capable of pointing to different combinations of the SDP's internal media components. For example, if a user/terminal changes from an English audio language stream to a French audio language stream, and also changes the primary/secondary scene streams, there does not need to be a separate SDP. Instead, another set of media components just has to be selected.

In various embodiments a media component level attribute “fref” is defined. “fref” stands for “fragment reference” and may be introduced into SDP. The “fref” can be associated with any individual media component and its scope is the SDP description. When referring to the SDP description, one can use format <sdp-ref>#<fref> in certain embodiments. Along the lines of a standard uniform resource identifier (URI) as disclosed, for example, in the Internet Engineering Task Force (IETF) Request for Comments (RFC) 2396, the “#” notation refers to a “fragment” of a target reference. In this instance, the target may comprise the media component that is associated with “fref” of the matching value.

The following is a fragmentary example SDP using the “fref” attribute.
v=0
o=−424 3292855200 IN IP6 FF15:0:0:0:0:0:81:1BC
s=Example
c=IN IP6 FF15:0:0:0:0:0:81:1BD
t=0 0
m=audio 49172 RTP/AVP 96
b=AS:64
a=fref:audio-A
a=rtpmap:96 mpeg4-generic/32000
a=fmtp:96 streamtype=5; profile-level-id=15; mode=AAC-hbr; config=1290;
SizeLength=13; IndexLength=3; IndexDeltaLength=3; Profile=1;
m=audio 49174 RTP/AVP 97
b=AS:64
a=fref:audio-B
a=rtpmap:97 mpeg4-generic/32000
a=fmtp:97 streamtype=5; profile-level-id=15; mode=AAC-hbr; config=1290;
SizeLength=13; IndexLength=3; IndexDeltaLength=3; Profile=1;
m=video 49170 RTP/AVP 98
b=AS:250
a=fref:video-A
a=rtpmap:98 H264/90000
a=fmtp:98 profile-level-id=42c00d; packetization-mode=1; sprop-parameter-sets=Z0LADZtAoPiA,aN4liA==;
m=video 12345 RTP/AVP 99
a=fref:rme-update-stream-1
a=rtpmap:99 richmedia+xml/100000
a=fmtp:99 Version-profile=10; Level=20
m=video 12345 RTP/AVP 99

The following is a sample SVG document referring to various parts of the SDP described above.

<?xml version=“1.0” encoding=“UTF-8”?>
<svg xmlns=“http://www.w3.org/2000/svg” version=“1.2”

xmlns:xlink=“http://www.w3.org/1999/xlink”
width=“480” height=“272” viewBox=“0 0 480 272”>

<desc>SVG example</desc>
<script type=“application/ecmascript”><![CDATA[

function change_lang(evt) {

var videoE = document.getElementById(“a1”);
videoE.setAttributeNS(“http://www.w3.org/1999/xlink”, “href”, “ id1234.sdp#audio-B”);

}

]]></script>
<g id=“top”>

<g id=“video”>

<video id=“v1” begin=“0s” xlink:href=“id1234.sdp#video-A” x=“0%” y=“0%” width=“480”

height=“272” transformBehavior=“geometrical” viewport-fill=“black” />

<audio id=“a1” begin=“0s” xlink:href=“id1234.sdp#audio-A” />
<rect x=“1” y=“1” width=“480” height=“272” fill=“none” stroke=“#777” stroke-width=“1”/>
<dims:updates id=“u1” xlink:href=“id1234.sdp#rme-update-stream-1” />

</g>
<g id=“button”>

<image x=“250” y=“130” width=“230” height=“132” opacity=“0” xlink:href=“foo.png”>

<handler type=“application/ecmascript” ev:event=“click”>change_lang(evt);</handler>

</image>

</g>

</g>

</svg>

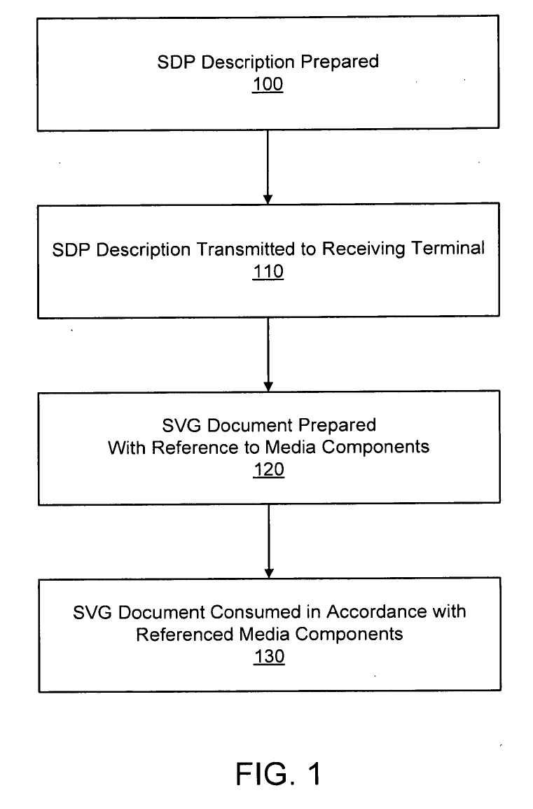

FIG. 1 is a flow chart showing an example implementation using the “fref” attribute described above. At 100 in FIG. 1, an SDP description is prepared, with the SDP description including multiple “fref” identifications, each referring to a different media component. At 110, the SDP description is transmitted from a sending device to a receiving device. At 120, an SVG document is prepared by the for the purpose of the receiving terminal “tuning in” to a new set of audio, video and/or RME streams. The receiving terminal uses the SDP description to identify one or more media components that are to be consumed by the receiving device. At 130, the receiving terminal processes the SVG document and consumes session content in accordance with the instructions contained within the SVG document. i.e., the receiving device tunes into the new set of audio, video and/or RME streams based upon the instructions contained within the SVG document.

Various embodiments also use different arrangements to enable faster session and scene setup time by carrying SDP descriptions and the latest full scene documents. In these embodiments, the process for acquiring session descriptions and full scenes is shortened, thereby shortening the time needed to re-tune the set of reception parameters. This may be accomplished, for example, by reusing a 3GPP DIMS unit for carrying scene and SDP information of sessions other than a current session. DIMS is disclosed in: 3GPP TS 26.142 V7.2.0 (2007-12); Technical Specification; 3GPP; Technical Specification Group Services and System Aspects; Dynamic and Interactive Multimedia Scenes (Release 7). In other embodiments, MIME multipart methods may be used to amend the result of the fetching of content such that the it includes additional scene and SDP information of sessions other than a current session. In still other embodiments, for a commonly shared session, a FLUTE-based carousel and associate change/update signaling is used.

Within a shared delivery session as part of RME document retrieval, information relating to a current RME session and other RME sessions is provided within the current RME session. The RME session is a session for delivering one or more RME streams, and an RME stream may comprise one or more full scene descriptions and/or one or more scene updates. According to various embodiments, transition-assisting information (TAI) is provided, including an SDP file for a session and the latest full SVG scene for that session. It should be noted that, if the session includes several scene delivery streams, there may be multiple “latest” full SVG scenes, with one scene for each stream. Therefore, the TAI comprises a set of SDP descriptions and/or SVG documents.

One embodiment comprises a method for carrying SDP descriptions and the latest full scenes, i.e., SVG documents, for other-than-current RME streams within the current RME stream. In a convention arrangement for streaming as specified for 3GPP DIMS, the TAI is carried either in the existing DIMS units or as specific new DIMS units. In the case of existing DIMS units, the TAI is concatenated after the main DIMS unit. All of the TAI can be included in one DIMS unit, or it can be distributed over a number of DIMS units. In either event, at the point of concatenation and just before each TAI, the TAI at issue is prefixed either with a uniform resource locator (URL) identifier and an optional version of the TAI, or a hash of the URL identifier together with the optional version of the TAI. The following two descriptions depict the case of an existing DIMS unit:
Extended_DIMS_Unit:==Existing_DIMS_Unit∥URL_of_TAI∥TAI
Extended_DIMS_Unit:==Existing_DIMS_Unit∥URL_of_TAI∥version∥TAI
Extended_DIMS_Unit:==Existing_DIMS_Unit∥hash_of_URL_of_TAI∥TAI
Extended_DIMS_Unit:==Existing_DIMS_Unit∥hash_of_URL_of_TAI∥version∥TAI)

The notation μ is for concatenation. An example of the first DIMS unit is as follows:

<Existing_DIMS_Unit>
http://foo.bar/a123.sdp
<content_of_http://foo.bar/a123.sdp>
http://foo.bar/a123.svg
<content_of_http://foo.bar/a123.svg>

An example of the second DIMS unit is as follows:

<Existing_DIMS_Unit>
0x5a25(hash of http://foo.bar/a123.sdp)
0x3 (version)
<content_of_http://foo.bar/a123.sdp, version 3>
0xde32(hash http://foo.bar/a123.svg)
0x5 (version)
<content_of_http://foo.bar/a123.svg, version 5>

The hash of the URL may be used instead of the URL itself as an identification, for example, when the URL itself is regarded to be too long. The hash of the URL may also used for ensuring that the URL has not been tampered with. The hash may be calculated by using, for example, Message Digest algorithm 5 (MD5), Secure Hash Algorithms SHA-1, SHA-3 or any other hash function.

When the existing DIMS unit is extended with concatenated TAI, the addition can be signalled by taking using the reserved “X” flags in the DIMS header (disclosed in §5.6.2 of the 3GPP DIMS document), for example setting “X”==0b01.

In the case of specific new DIMS units for carrying TAI, this case is similar to the case involving existing DIMS units in some respects. However, in the case of specific new DIMS units, there is no <Existing_DIMS_Unit>. However, the specific new DIMS unit can be signalled by taking using the reserved “X” flags in the DIMS header (as disclosed in §5.6.2 of the 3GPP DIMS document), for example setting “X”==0b10.

Another embodiment involves carrying SDP descriptions and the latest full scenes (i.e., SVG documents) for all RME streams within a commonly shared file delivery. In this embodiment, there is a common file delivery session, such as a common asynchronous layered coding (ALC)/FLUTE-based file delivery session, that all or some of the RME sessions share. This common session delivers the TAI information so that each piece of TAI appears as an individual transport object or so that a number of TAI pieces are concatenated into a single transport object. This can be accomplished using either a “multipart MIME RELATED” or “multipart MIME MIXED” messages. Further, if FLUTE or ALC is used for the session, then the session management and change identification systems such as those specified for FLUTE and ALC in Open Mobile Alliance Digital Mobile Broadcast (OMA BCAST) can be used to monitor, identify and locate the changes in the common session.

If one desires to save RME agents polling the common session, the following system can be applied, enabling RME agent to remain on a current session without having to periodically poll the common session. First, upon a change in a common session, the change is signalled in each specific RME (DIMS) session that is considered relevant. In the specific RME session(s), the change is signalled either “piggy backing” on the change in an existing DIMS unit or by defining a specific new DIMS unit for such signalling. In the case of a new DIMS unit being defined, this can be signalled by using the reserved “X” flags in the DIMS header (as disclosed in §5.6.2 of the 3GPP DIMS document), for example setting “X”==0b11.

Still another embodiment involves carrying SDP descriptions and the latest full scenes, i.e., SVG documents, for other than current RME scenes when the current RME scene is fetched, for example using hypertext transfer protocol (HTTP). In this case, the RME agent or a similar device has requested a scene using, for example, a HTTP GET request. In response to this request, the RME agent receives an HTTP OK message with, for example, the following payload:

---------Multipart Message - Begin--------------------------
Content-type: multipart/mixed; boundary=“RME”
--RME
Content-type: application/richmedia+xml
Content-location: http://foo.bar/a123.svg
<<initial SVG scene goes here>>
--RME
Content-type: application/sdp
Content-location: http://foo.bar/a123.sdp
<<sdp description goes here>>
--RME--
---------Multipart Message - End--------------------------

In this situation, either “multipart MIME RELATED” or “multipart MIME MIXED” messages can be used. Furthermore, a single response can piggyback on one or more pieces of TAI.

The following is a discussion of how the RME agent can make use of TAI information in order to shorten the scene and session setup time. Upon a change to a new SDP session, the RME agent determines whether it already has received an SDP file as part of TAI for session XYZ (e.g., an SDP file identified by the URL XYZ.sdp). If the agent has received an SDP file as part of TAI for session XYZ, then the agent uses it without trying to retrieve it over a network connection. In the vent that the RME agent determines that the change involves the change of primary RME stream, then the agent performs a lookup in order to determine whether it already has received the SVG file identified by URL XYZ.svg. It should be noted that, in one embodiment, the name of SDP and SVG files is the same—only the extension is different. If the agent has received the SVG file identified by URL XYZ.svg, then the agent uses it without trying to retrieve it over the network connection. Meanwhile, the agent can tune to the audio/video stream and the new primary/secondary RME streams. If the TAI information was matching, then, by the time agent has performed the tune-in, the agent also has the primary scene setup and can directly start applying scene updates to the setup.

In addition, the name of base scene SVG file can also be identified according to various embodiments. Such an identification is useful in the event that the receiving terminal wishes to acquire the base scene prior to tune-in. In these embodiments, the base scene SVG file is identified using a sub-attribute referred to as “base-svg” within the “fmtp” attribute line that is associated with media component describing the RME stream. This attribute is depicted in use in the example below:
sdp1234.sdp
- - -
v=0
o=−424 3292855200 IN IP6 FF15:0:0:0:0:0:81:1BC
s=Example
c=IN IP6 FF15:0:0:0:0:0:81:1BD
t=0 0
m=audio 49172 RTP/AVP 96
b=AS:64
a=fref:audio-A
a=rtpmap:96 mpeg4-generic/32000
a=fmtp:96 streamtype=5; profile-level-id=15; mode=AAC-hbr; config=1290;
SizeLength=13; IndexLength=3; IndexDeltaLength=3; Profile=1;
m=video 49170 RTP/AVP 97
b=AS:250
a=fref:video-A
a=rtpmap:97 H264/90000
a=fmtp:97 profile-level-id=42c00d; packetization-mode=1; sprop-parameter-sets=Z0LADZtAoPiA,aN4liA==;
m=video 12345 RTP/AVP 98
a=fref:rme-update-stream-1
a=rtpmap:98 richmedia+xml/100000
a=fmtp:98 Version-profile=10; Level=20; base-svg=svg1234.svg
m=video 12345 RTP/AVP 99
a=fref:rme-update-stream-2
a=rtpmap:99 richmedia+xml/100000
a=fmtp:99 Version-profile=10; Level=20; base-svg=svg1235.svg

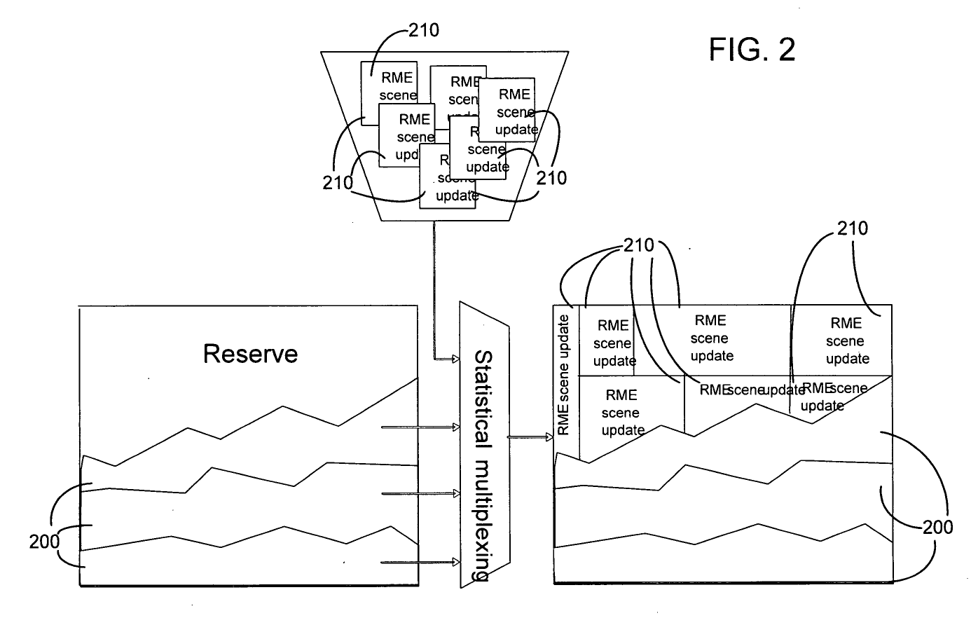

Various embodiments also may use statistical multiplexing so that RME scene updates can be provided along with associated media streams in an efficient manner. As mentioned previously, statistical multiplexing provides a mechanism by which to make maximum use of available bandwidth. In statistical multiplexing, a communication channel is divided into a plurality of variable bit-rate digital channels or data streams. The link sharing is adapted to the traffic demands of the data streams that are transferred over each channel at a given moment. FIG. 2 is a general representation showing a process by which statistical multiplexing may be used to provide RME scene update information along with associated media streams. RME scene updates may include, for example and but not limited to, advertisements, news alerts, stock tickers, weather alerts, traffic information, document object model (DOM) updates and other types of information. As can be observed in FIG. 2, plurality of audio/video streams 200 are transmitted in a session, with some reserve bandwidth remaining. Importantly, the individual bit rates for each of these audio/video streams 200 may vary over time. Individual RME streams and RME scene updates also may exhibit this behavior. In the case of RME scene updates, these updates can vary drastically in size. Statistical multiplexing is therefore used to include individual RME scene updates 210 in the reserve bandwidth in as efficient a manner as possible.

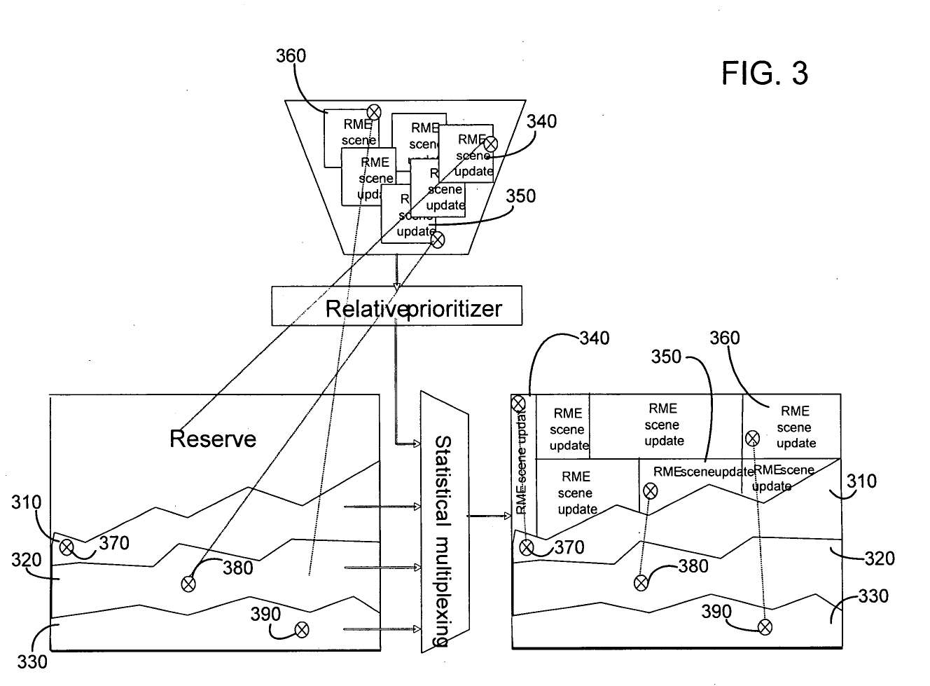

In addition to the above, the statistical multiplexing of RME scene updates can be performed in a “context-aware” arrangement. In such a system, RME scene updates are prioritized based upon one or more factors before multiplexing. FIG. 3 is a representation showing how a relative prioritizer may be used in combination with statistical multiplexing in order to associate individual RME scene updates with media streams. As shown in FIG. 3, first, second and third individual RME scene updates 310, 320 and 330 are associated with first, second and third individual content streams 340, 350 and 360 in the session. It should be noted that, for simplicity purposes, only three content streams are shown in FIG. 3, and only three RME scene updates are shown as being associated with the three shown content streams. The non-identified RME scene updates should be considered as corresponding to content streams that are not shown.

In the first, second and third content streams 340, 350 and 360 of FIG. 3, first, second and third association points 370, 380 and 390 are shown, each of which represents the point in time where the corresponding RME scene update is to be consumed. Given that individual RME scene updates are to be rendered at different times, the time at which each RME scene update is to be rendered is one factor that may be used to prioritize individual RME content streams. Considering the situation depicted in FIG. 3, for example, it would be preferable for the first RME scene update 310 to be delivered before the second or third RME scene updates 320 and 330, since the first RME scene update 310 is to be used first in the rendering of the associated content stream.

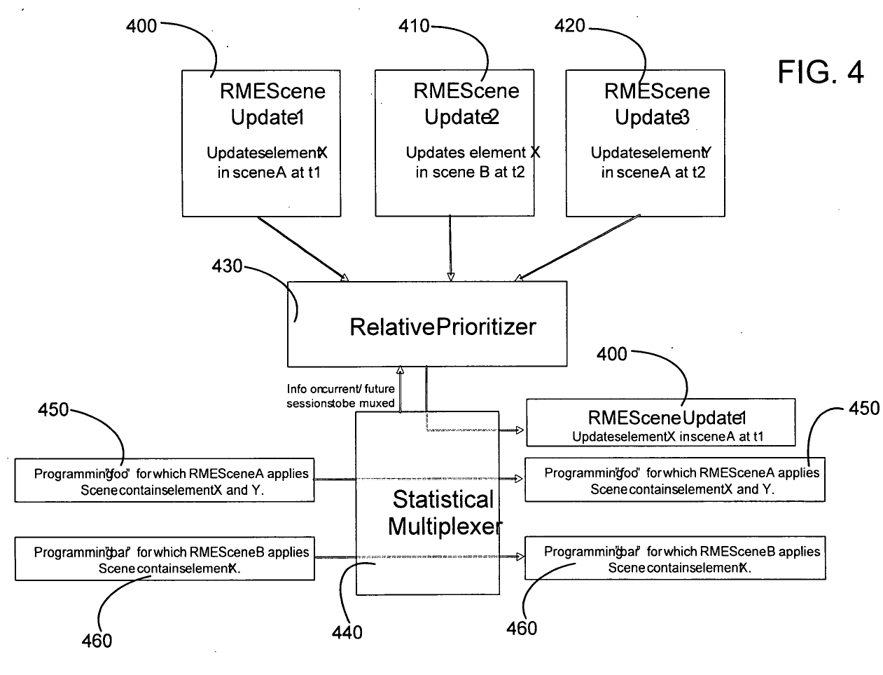

In various embodiments, when deciding which RME scene update(s) should be prioritized, factors which may be considered include (1) the RME timelines of currently multiplexed programming or content streams; (2) the current time; (3) which element each RME scene update is intended to update; and (3) available reserve/bandwidth in the individual content session. In one particular embodiment, these four factors are considered together in deciding which RME scene update(s) should be inserted first. FIG. 4 shows how such factors may be used in prioritizing first, second and third RME scene updates 400, 410 and 420. As depicted in FIG. 4, each of the first, second and third RME scene updates 400, 410 and 420 is provided to a relative prioritizer 430. The relative prioritizer 430 notes that the current time is t1, the time at which element X is to be updated in the first RME scene update 400 is t1, and the amount of reserve available for including RME scene update information that is based upon information provided by a statistical multiplexer 440. As such, the relative prioritizer 430 comes to the conclusion that the first RME scene update 400 should be given priority over the second and third RME scene updates 410 and 420.

This priority information is provided to the statistical multiplexer 440 along with the first, second and third RME scene updates 400, 410 and 420 and first and second content streams 450 and 460. The statistical multiplexer 440 uses in terms transmit a content session at time t1 including the first and second content streams 450 and 460 as well as the first RME scene update 400.

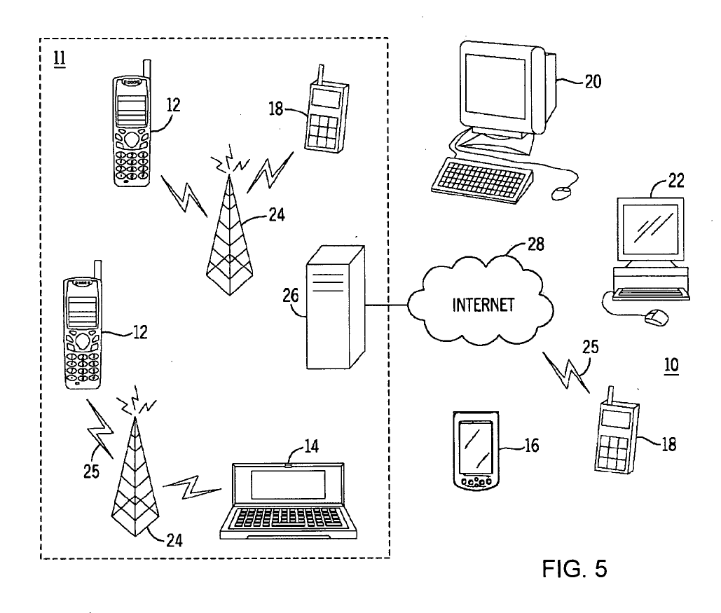

FIG. 5 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments may communicate using various media including, but not limited to, radio, infrared, laser, cable connection, and the like.

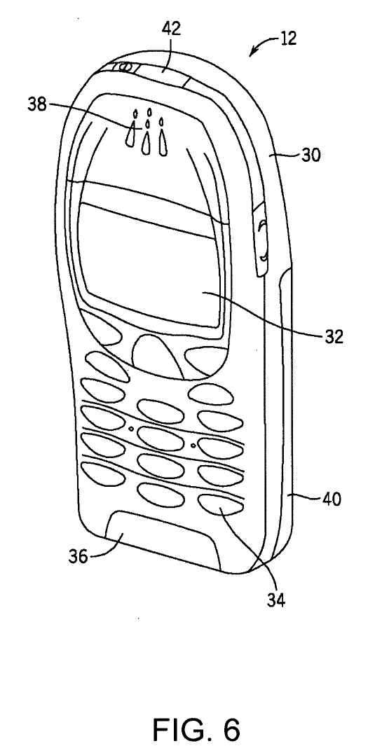

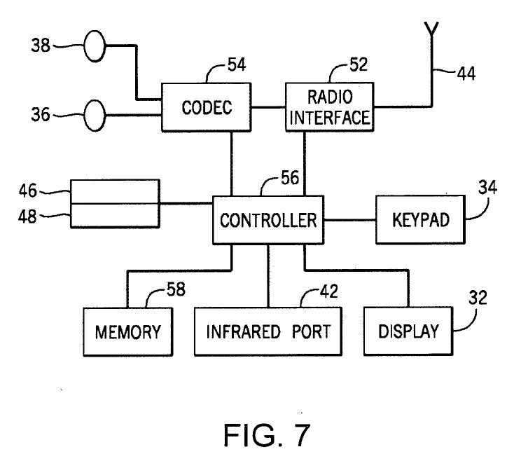

FIGS. 6 and 7 show one representative electronic device 12 within which various embodiments may be implemented. It should be understood, however, that the embodiments are not intended to be limited to one particular type of device. The electronic device 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

The various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
processing a document comprising instructions regarding the consumption of at least one media component in a rich media environment session;
using a previously received session description protocol description to identify the at least one media component; and
consuming the at least one media component in accordance with the instructions in the document.

2. The method of claim 1, wherein the at least media component is identified in the session description protocol description using a fragment reference identifier.

3. A computer program product, embodied in a computer-readable storage medium, comprising computer code configured to perform the processes of claim 1.

4. An apparatus, comprising:
a processor; and
a memory unit communicatively connected to the processor and including:
computer code configured to process a document containing instructions regarding the consumption of at least one media component in a rich media environment session;
computer code configured to use a previously received session description protocol description to identify the at least one media component; and
computer code configured to consume the at least one media component in accordance with the instructions in the document.

5. The apparatus of claim 4, wherein the document comprises a scalable vector graphics document.

6. The apparatus of claim 4, wherein the at least media component is identified in the session description protocol description using a fragment reference identifier.

7. A method, comprising:
providing a current rich media environment session comprising a current rich media environment stream to a receiving terminal for consumption; and
providing, within the current rich media environment session, information concerning the current rich media environment stream and at least one rich media environment stream other than the current rich media environment stream.

8. The method of claim 7, wherein the information comprises at least one session description protocol description and at least one latest full scene for at least one other-than-current rich media environment stream, and wherein the information is provided within the current rich media environment session.

9. The method of claim 7, wherein the information is provided within a commonly shared file delivery session, and wherein the information comprises at least one session description protocol description and latest full scenes for all rich media environment streams within the commonly shared file delivery session.

10. The method of claim 7, wherein the information comprises at least one session description protocol description and at least one latest full scene for at least one other-than current rich media environment stream, and wherein the information is provided when a current rich media environment scene is fetched.

11. A computer program product, embodied in a computer-readable storage medium, comprising computer code configured to perform the processes of claim 7.

12. An apparatus, comprising:
a processor; and
a memory unit communicatively connected to the processor and including:
computer code configured to provide a current rich media environment session comprising a current rich media environment stream to a receiving terminal for consumption; and
computer code configured to provide, within the current rich media environment session, information concerning the current rich media environment stream and at least one rich media environment stream other than the current rich media environment stream.

13. The apparatus of claim 12, wherein the information comprises at least one session description protocol description and at least one latest full scene for at least one other-than-current rich media environment stream, and wherein the information is provided within the current rich media environment session.

14. The apparatus of claim 12, wherein the information is provided within a commonly shared file delivery session, and wherein the information comprises at least one session description protocol description and latest full scenes for all rich media environment streams within the commonly shared file delivery session.

15. The apparatus of claim 12, wherein the information comprises at least one session description protocol description and at least one latest full scene for at least one other-than current rich media environment stream, and wherein the information is provided when a current rich media environment scene is fetched.

16. An apparatus, comprising:
a processor; and
a memory unit communicatively connected to the processor and including:
computer code configured to provide a plurality of content streams for transmission during a rich media environment session;
computer code configured to provide a plurality of rich media environment scene updates for transmission in conjunction with the plurality of content streams, each rich media environment scene update being associated with at least one of the plurality of content streams; and
computer code configured to statistically multiplex the plurality of rich media environment scene updates and the plurality of content streams so as to efficiently transmit the plurality of rich media environment scene updates along with the plurality of content streams.

17. The apparatus of claim 16, wherein the memory unit further comprises, before performing statistical multiplexing, computer code configured to prioritize the plurality of rich media environment scene updates so that rich media environment scene updates with a higher priority are transmitted before rich media environment scene updates with a lower priority.

18. The apparatus of claim 16, wherein the relative priority of each rich media environment scene update is based upon at least one of a current time, rich media environment timelines of the plurality of content streams, which elements each rich media environment scene update is intended to update, and available reserve bandwidth in the rich media environment session.
